(19) United States
(12) Patent Application Publication
(10) Pub. No.: US 2014/0188741 A1
(43) Pub. Date: Jul. 3, 2014

(54) Care Advice System & Method

(71) Applicant: Richard S. Lustberg, Dix Hills, NY (US)

(72) Inventor: Richard S. Lustberg, Dix Hills, NY (US)

(21) Appl. No.: 13/732,575

(22) Filed: Jan. 2, 2013

(51) Int. Cl. G06Q 30/00; G06Q 50/00

(52) U.S. Cl. CPC G06Q 30/01; G06Q 50/01
USPC 705/319

(57) ABSTRACT

A care advice method, including: visiting a care advice website; registering as a customer on the website; completing a care request for advice from at least one expert; notifying each selected expert electronically of pending care request for advice; responding to the care request by at least one expert providing advice; uploading the advice to the website; submitting the advice which is delivered to the recipient defined by the customer; posting the advice to website which can be viewed by all viewers; and providing customers the option to post comments on the advice posted.

### CROSS REFERENCE TO RELATED APPLICATIONS

This application claims priority from U.S. Patent Application No. having Ser. No. 61/737,139 having a filing date of 14 Dec. 2012.

### BACKGROUND OF THE INVENTION

The invention relates to providing a Care Advice System and Method, including, inter alia, wherein an individual electronically submits a request for Care Advice for oneself, or a third-party, from at least one Expert, and that Care Advice is published for the general public to view via a website, and for Customers to comment thereon.

### SUMMARY OF INVENTION

A care advice method, including: visiting a care advice website; registering as a customer on the website; completing a care request for advice from at least one expert; notifying each selected expert electronically of pending care request for advice; responding to the care request by at least one expert providing advice; uploading the advice to the website; submitting the advice which is delivered to the recipient defined by the customer; posting the advice to website which can be viewed by all viewers; and providing customers the option to post comments on the advice posted.

Other objectives, advantages, and novel features of the present invention will become more apparent from the following detailed description when taken in conjunction with the accompanying drawings.

### BRIEF DESCRIPTION OF THE DRAWINGS

The following drawings, in which like reference characters indicate like parts, are provided for illustration of the invention and are not intended to limit the invention in any manner whatsoever.

FIG. 1 is a flow chart illustrating methods consistent with the present invention for providing care advice;

FIG. 2 is a flow chart illustrating methods consistent with the present invention for providing a caregramm; and

FIG. 3 illustrates an exemplary system in which concepts consistent with the present invention may be implemented.

### DETAILED DESCRIPTION OF INVENTION

A Care Advice System and method comprising a website that provides the general public (aka viewers) access to view care requests and responses (aka advices), however, in order to post comments on the site, individuals/viewers must become a Customer (aka users) by registering on the site by providing a valid email address, their full name, and attest to being the age of the majority, although no credit card is required to obtain a user name, Customers can utilize all areas of the site (i.e. chat, forum, video viewing, etc.). Customers visit the site to create a Care Request for Advice from one or more Experts, wherein the list of fields of Experts will be extensive and fluid, wherein the Care Request is submitted to the site through an array of methods, such as via text, audio or video by the Customer. At least one Expert is selected by the Customer directly on the site (i.e. if an Expert is advertising dieting, a Customer may wish to ask advice of this particular diet Expert), and wherein one or more Recipients of the Care Request advices are defined by the Customer. It is envisioned that the panel of experts include, inter alia, psychologist, social worker, psychiatrist, professor, teacher, clergy (e.g., Pastor, Priest, Rabbi, etc.), psychic, astrologer, comedian, peer, and life coach.

Once the Care Request is submitted by the Customer, the selected Expert(s) will receive an email serving notice that a Care Request awaits the Expert's action of providing advice. Once an Expert clicks on the email, the Expert will be taken to the Care Request on the site, whereafter, each selected Expert can video-record and upload their Advice to the site which is sent to the proper Recipient(s) previously defined by the Customer in the original Care Request. The advice is then (i) delivered to the designated Recipient as defined by the Customer, whether it is the Customer themselves, and/or a third party, and (ii) it is posted to the site, and hence can be viewed by all viewers, but only Customers may post comments, and wherein Videos will be posted to social media sites, including, but not limited to YOUTUBE®, FACEBOOK®, GOOGLE®, TWITTER® and other Social Media sites.

Experts have the option to advertise their products and services, as part of their biographic description, and optionally may be charged a fee if such advertising option is selected by the Expert.

Furthermore, Customers may request a Caregramm from an Expert by paying a fee, wherein an Expert delivers a personalized video ‘e-card’ to a Customer: i.e. song, poem, prose, etc. from Caregrammers. Prior to requesting a Caregramm, a Customer will be directed to a payment screen where the Customer must enter billing information in order to proceed. The Customer will select from a menu of options to purchase one or more Caregramms, wherein each Caregramm is private and thus will not be posted on the main site for all to see, unless selected by the recipient and/or the customer that the Caregramm become non-private.

It is further envisioned that the method and system will include, but shall not be limited to, the following; ‘Webisodes’ that will trace a Customer's Care Advice Request and consequent recommendations/actions; periodic interactive live Web-discussions/panels conducted by Experts; Customer contests and Polls; Customer Chat rooms; and wherein Experts will conduct webinars.

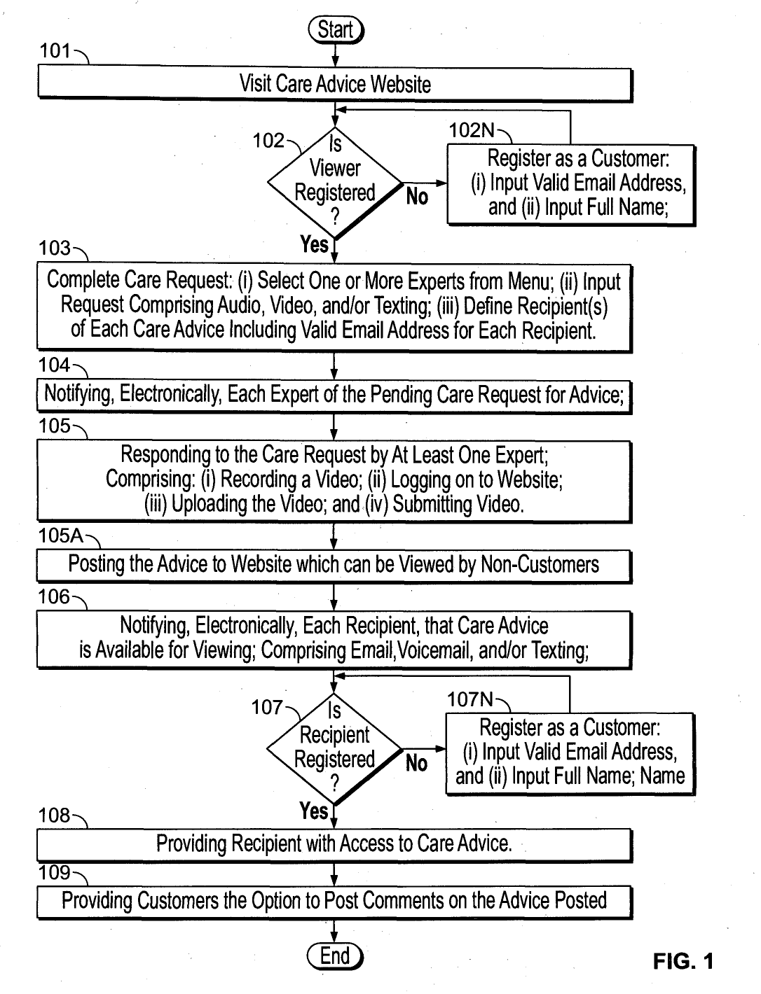

FIG. 1 is a flow chart illustrating a Caregramm method set forth hereinabove. An individual visits a care request website 101, and the inquiry of whether the individual is registered 102, if not registered, then the customer needs to register by entering a valid email address and their full name 102N, alternatively, if the individual is previously registered, then they proceed directly to 103, wherein the customer completes a care request by: (i) selecting one or more experts from menu; (ii) inputting their request comprising audio, video, and/or texting; and (iii) defining recipient(s) of each care request including valid email address for each recipient. Once the request 103 is completed, each expert is notified, electronically, of the pending care request for advice 104. The expert responds to the care request by (i) recording a video; (ii) logging on to the website (iii) uploading the video; and (iv) submitting the video, whereafter the advice is posted 105A to the website, and which can be viewed by all, wherein commenting is limited to customers, and notice is electronically sent 106 to each recipient that the care advice is available for viewing comprising email, voice and/or text. Each recipient is identified when visiting the website 107, if registered, then they proceed to step 108, where they are granted access to their care advice; if not registered, then the recipient must register as a customer 107N by inputting a valid email address and their full name, once registration is complete, they are granted access 108 to their care advice and to post comments 109.

Moreover, while series of acts have been presented with respect to the figures, the order of the acts may be different in other implementations consistent with the present invention.

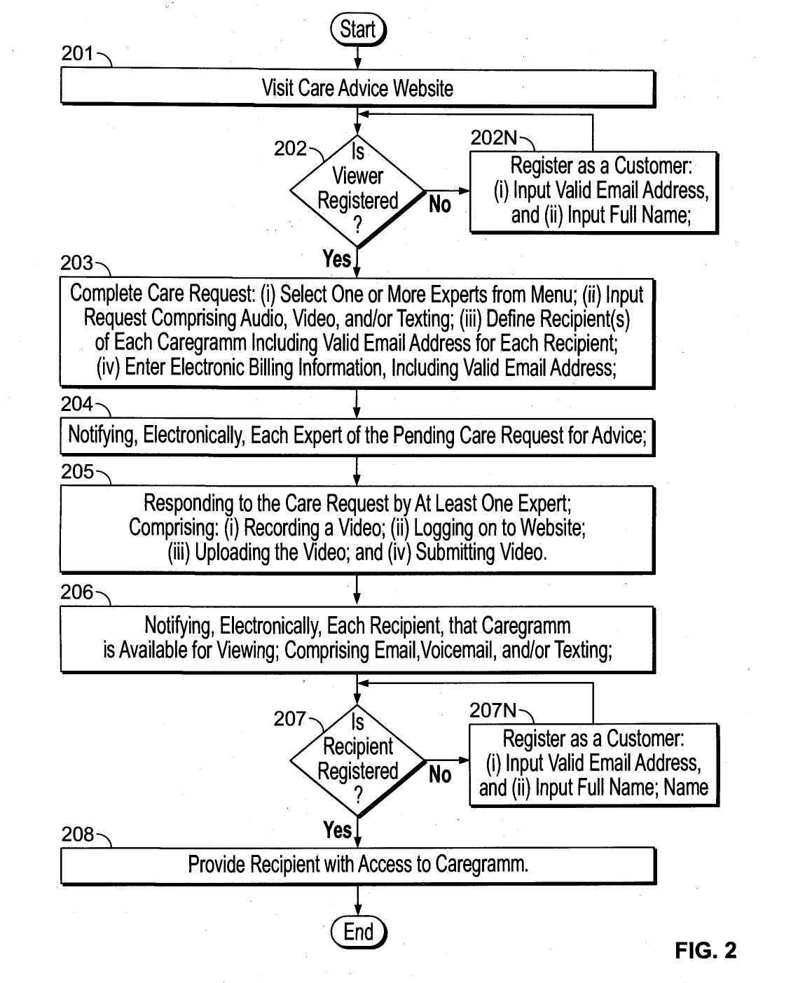

FIG. 2 is a flow chart illustrating a Caregramm method set forth hereinabove. An individual visits a care request website 201, and the inquiry of whether the individual is registered 202, if not registered, then the customer needs to register by entering a valid email address and their full name 202N, alternatively, if the individual is previously registered, then they proceed directly to 203, wherein the customer completes a care request by: (i) selecting one or more experts from menu; (ii) inputting their request comprising audio, video, and/or texting; (iii) defining recipient(s) of each Caregramm including valid email address for each recipient; and (iv) entering electronic billing information, including yard email address. Once the request 203 is completed, each expert is notified, electronically, of the pending care request for advice 204. The expert responds to the care request by (i) recording a video; (ii) logging on to the website (iii) uploading the video; and (iv) submitting the video, whereafter notice is electronically sent 206 to each recipient that the Caregramm is available for viewing comprising email, voicemail, and/or text. Each recipient is identified when visiting the website 207, if registered, then they proceed to step 208, where they are granted access to their Caregramm; if not registered, then the recipient must register as a customer 207N by inputting a valid email address and their full name, once registration is complete, they are granted access 208 to their Caregramm.

Moreover, while series of acts have been presented with respect to the figures, the order of the acts may be different in other implementations consistent with the present invention.

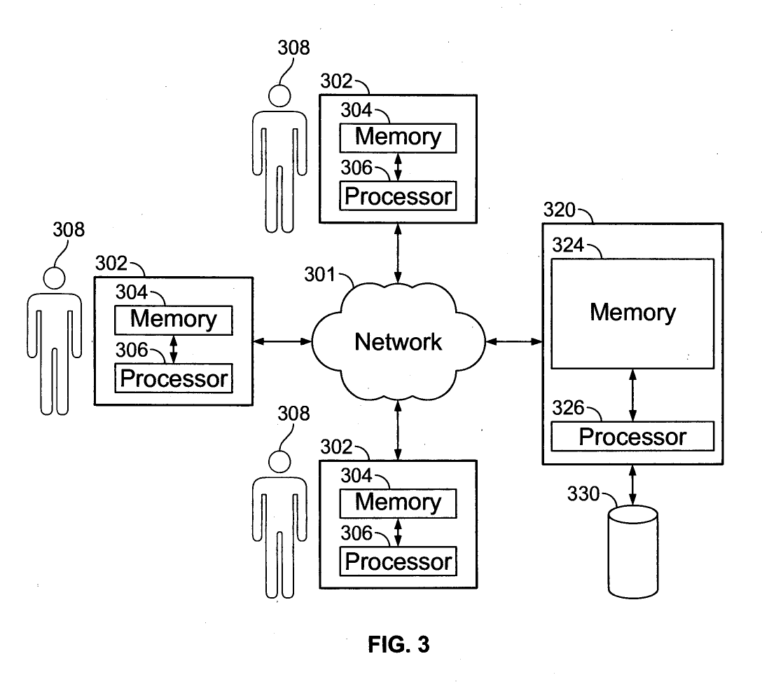

FIG. 3 is a diagram illustrating an exemplary system in which concepts consistent with the present invention may be implemented. The system includes multiple network 301, client devices 302, a server device 320, and, which may be, for example, the Internet. Client devices 302 each include a computer-readable medium 304, such as random access memory, coupled to a processor 306. Processor 306 executes program instructions stored in memory 304. Client devices 302 may also include a number of additional external or internal devices, such as, without limitation, a mouse, a CD-ROM, a keyboard, and a display. Through client devices 302, users 308 can communicate over network 301 with each other 308 and with other systems and devices coupled to network 301, such as server device 320.

Similar to client devices 302, server device 320 may include a computer readable memory 324 coupled to a processor 326. Server device 320 may additionally include a secondary storage element, such as database 330. Client processors 306 and server processor 326 can be any of a plethora of well known computer processors, such as processors from Intel Corporation. In general, client device 302 may be any type of computing platform connected to a network and that interacts with application programs, such as a digital assistant or a “smart” cellular telephone or tablet. Server 320, although depicted as a single computer system, may be implemented as a network of computer processors.

All of the above referenced patents; patent applications and publications are hereby incorporated by reference. Many variations of the present invention will suggest themselves to those of ordinary skill in the art in light of the above detailed description. All such obvious modifications are within the full-intended spirit and scope of the claims of the present application, including equivalents thereof.

1. A care advice method, comprising:
visiting a care advice website;
registering as a customer on the website;
completing a care request for advice from at least one expert;
notifying, electronically, each selected expert of the pending care request for advice;
responding to the care request by at least one expert providing advice;
notifying, electronically, each recipient predefined by the customer that care advice is available for the recipient's viewing;
posting the advice to website which can be viewed by all viewers; and
providing customers the option to post comments on the advice posted.

2. A method as in claim 1, wherein completing a care request for advice further includes:
selecting from a menu of options;
inputting a request comprising an audio, a video, and text; and
defining desired recipient(s) of each care request wherein a valid email address is provided.

3. A method as in claim 1, wherein the notifying, electronically, of the at least one expert comprises: email, voicemail, and texting.

4. A method as in claim 1, wherein the responding to the care request by the at least one expert comprises:
recording a video;
logging on to the website by the requested expert;
uploading the video recording to the website; and
submitting the upload.

5. A method as in claim 1, wherein the notifying, electronically, each recipient predefined by the customer comprises: email, voicemail, and texting.

6. A method as in claim 1, further comprising:
posting responses by at least on expert to social media sites.

7. A care advice method, comprising:
visiting a care advice website;
registering as a customer on the website if not already registered;
completing a care request for advice from at least one expert; wherein said care request is a Caregramm request;
notifying, electronically, each selected expert of the pending care request for advice;
responding to the care request by at least one expert providing advice;
notifying, electronically, each recipient predefined by the customer that a Caregramm is available for the recipient's viewing; and
providing each unregistered recipient with a registration process to access said Caregramm.

8. A method as in claim 7, wherein completing a care request for advice further includes:
selecting from a menu of options at least one Caregramm;
inputting a request comprising an audio, a video, and text;
defining desired recipient(s) of each Caregramm wherein a valid email address is provided, and
entering electronic billing information, including a valid email address.

9. A method as in claim 7, wherein the notifying, electronically, of the at least one expert comprises: email, voicemail, and texting.

10. A method as in claim 7, wherein the responding to the care request by the at least one expert comprises:
recording a video;
logging on to the website by the requested expert;
uploading the video recording to the website; and
submitting the upload.

11. A method as in claim 7, wherein the notifying, electronically, each recipient predefined by the customer comprises: email, voicemail, and texting.

12. A method as in claim 7, further including:
predefining a Caregramm as private, while providing an option for the Caregramm to be posted to the website.

13. A system comprising:
a server connected to a network, the server receiving search queries from users via the network, the server including:
at least one processor;
a database of a corpus; and
a memory operatively coupled to the processor, the memory storing program instructions that when executed by the processor, cause the processor to:
provide access to a care advice website;
register as a customer on the website if not already registered;
complete a care request for advice from at least one expert; wherein said care request is a Caregramm request;
notify, electronically, each selected expert of the pending care request for advice;
provide access to the care request by at least one expert providing advice;
notify, electronically, each recipient predefined by the customer that a Caregramm is available for the recipient's viewing; and
provide each unregistered recipient with a registration process to access said Caregramm.

14. A care advice system comprising:
means for visiting a care advice website;
means for registering as a customer on the website;
means for completing a care request for advice from at least one expert;
means for notifying, electronically, each selected expert of the pending care request for advice;
means for responding to the care request by at least one expert providing advice;
means for posting the advice to website which can be viewed by all viewers; and
means for providing customers the option to post comments on the advice posted.

15. A system as in claim 14, wherein completing a care request for advice further includes:
means for selecting from a menu of options;
means for inputting a request comprising an audio, a video, and text;
means for defining desired recipient(s) of each care request wherein a valid email address is provided, and
means for entering electronic billing information, including a valid email address.

16. A system as in claim 14, wherein the means for notifying, electronically, of the at least one expert comprises: email, voicemail, and texting.

17. A system as in claim 14, wherein the means for responding to the care request by the at least one expert comprises:
means for recording a video;
means for logging on to the website by the requested expert;
means for uploading the video recording to the website; and
means for submitting the upload.

18. A system as in claim 14, wherein the means for notifying, electronically, each recipient predefined by the customer comprises: email, voicemail, and texting.

19. A system as in claim 14, further comprising:
means for posting responses by at least on expert to social media sites.

20. A care advice system, comprising:
means for visiting a care advice website;
means for registering as a customer on the website if not already registered;
means for completing a care request for advice from at least one expert;
wherein said care request is a Caregramm request;
means for notifying, electronically, each selected expert of the pending care request for advice;
means for responding to the care request by at least one expert providing advice;
means for notifying, electronically, each recipient predefined by the customer that a Caregramm is available for the recipient's viewing; and
means for providing each unregistered recipient with a registration process to access said Caregramm.

21. A system as in claim 20, wherein means for completing a care request for advice further includes:
means for selecting from a menu of options at least one Caregramm;
means for inputting a request comprising an audio, a video, and text;
means for defining desired recipient(s) of each Caregramm wherein a valid email address is provided, and
means for entering electronic billing information, including a valid email address.

22. A system as in claim 20, wherein the means for notifying, electronically, of the at least one expert comprises: email, voicemail, and texting.

23. A system as in claim 20, wherein the means for responding to the care request by the at least one expert comprises:
means for recording a video;
means for logging on to the website by the requested expert;
means for uploading the video recording to the website; and
means for submitting the upload.

24. A system as in claim 20, wherein the means for notifying, electronically, each recipient predefined by the customer comprises: email, voicemail, and texting.

25. A system as in claim 20, further including:
means for predefining a Caregramm as private, while providing an option for the Caregramm to be posted to the website.
